(19) United States
(12) Patent Application Publication
(10) Pub. No.: US 2004/0259990 A1
(43) Pub. Date: Dec. 23, 2004

(54) Paint formulation for a low surface energy substrate

(76) Inventors: Mark F. Sonnenschein, Midland, MI (US); Benjamin L. Wendt, Chesaning, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/862,614

(22) Filed: Jun. 7, 2004

Related U.S. Application Data
(60) Provisional application No. 60/479,292, filed on Jun. 18, 2003.

(51) Int. Cl. C08F 4/52

(52) U.S. Cl. 524/236; 526/319

(57) ABSTRACT

The present invention relates to a curable paint formulation and a curing paint formulation prepared therefrom. The curable formulation comprises a curable acrylic-based paint and a trialkylborane-organonitrogen complex. Curing of this formulation can be initiated by contact with a borane-displacing initiator. The curing paint formulation, when applied to a low surface energy substrate such as isotactic polypropylene, is capable of forming an adherent cured coating with little or no cross-hatch failure. Moreover, the application of the curing paint formulation onto the substrate can be carried out at room temperature and without the aid of substrate surface pretreatment or a tie layer.

### CROSS-REFERENCE STATEMENT

This application claims the benefit of U.S. Provisional application No. 60/479,292 filed Jun. 18, 2003.

### BACKGROUND OF THE INVENTION

This invention relates to a paint formulation particularly suitable for a low surface energy substrate.

Polyolefins such as polyethylene and polypropylene and copolymers thereof are useful in the fabrication of automobile bodies and trim. These polymers are lightweight and have excellent impact resistance—they can withstand low speed collision better than their metal counterparts—but, to be aesthetically acceptable, they must be painted to match the paint on the rest of the automobile. Unfortunately, the inherent low surface energy of polyolefins inhibits adhesion to most paint formulations, which tend to contain polar materials such as urethanes, acrylics, epoxies, and melamines. Consequently, efforts have been directed toward pretreating the surface of these materials to render them paintable. Such pretreatments include vapor cleaning, defatting, acid treatment, corona discharge treatment, or plasma treatment. Other efforts to improve adhesion have been directed to the use of tie layers, also known as adhesion promoters. Unfortunately, such techniques are often cumbersome, costly, and environmentally unsound. Accordingly, it would be advantageous to discover a simple way of adhering paint to a low surface energy substrate that does not require surface pretreatment or the use of an adhesion promoter.

### SUMMARY OF THE INVENTION

The present invention addresses a deficiency in the art by providing a composition comprising a mixture of a curable acrylic-based paint and a trialkylborane-organonitrogen complex, wherein the curable acrylic-based paint contains a solvent and an acrylic monomer.

In a second aspect, the present invention is a method comprising the steps of 1) contacting together a curable acrylic-based paint, a trialkylborane-organonitrogen complex, and a trialkyborane-displacing initiator to form a curing acrylic-based paint; and 2) applying the curing paint to a substrate; and 3) allowing the curing paint to cure.

In a third aspect the present invention is a composition comprising a mixture of a curing acrylic-based paint, a borane-displacing initiator, and a trialkylborane-organonitrogen complex, wherein the curing acrylic-based paint contains a solvent and a polymerizing acrylic monomer, the borane-displacing initiator selected from the group consisting of acids, isocyanates, acid chlorides, and anhydrides, trialkylborane-organonitrogen complex wherein the organonitrogen is selected from the group consisting of primary amines, secondary amines, tertiary amines, diamines, pyridines, and pyrrolidines.

The low surface energy paint precursor, in combination with the borane-displacing initiator, provides a paint that contains a polar resin but that adheres to a low surface energy substrate without the aid of a pretreatment step or a tie layer.

### DETAILED DESCRIPTION OF THE INVENTION

The first aspect of the present invention is a composition that comprises a mixture of a curable acrylic-based paint and a trialkylborane-organonitrogen complex. This mixture, when initiated with a suitable initiator, forms a cured paint that is capable of adhering to the surface of a low surface energy substrate. However, as distinct from an adhesive, the cured paint is not capable of bonding other substances together. Furthermore, the cured paint, as opposed to an adhesive, forms a contiguous film on the surface of the substrate.

The term “acrylic monomer” is used herein to refer to an acrylamide monomer, an acrylonitrile monomer, or an acrylate monomer, with acrylate monomers being preferred. Acrylate monomers have the chemical structure:

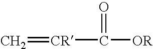

where R is a substituent other than H; preferably alkyl, cycloalkyl, bicycloalkyl, or hydroxyalkyl, more preferably C₁-C₆-alkyl, isonorbornyl, or hydroxyethyl; and R′ is a substituent, preferably hydrogen or C₁-C₆-alkyl, more preferably hydrogen, methyl, or ethyl.

Examples of suitable acrylic monomers include acrylonitrile, acrylamide, n-methylacrylamide, methyl acrylate, ethyl acrylate, n-propyl acrylate, n-butyl acrylate, t-butyl acrylate, isobornyl acrylate, 2-hydroxyethyl acrylate, hydroxypropyl acrylate, glycidyl acrylate and ethyl-n-hexyl acrylate, methyl methacrylate, ethyl methacrylate, n-propyl methacrylate, n-butyl methacrylate, t-butyl methacrylate 2-hydroxyethyl methacrylate, hydroxypropyl methacrylate, isobornyl methacrylate, glycidyl methacrylate, tetrahydrofurfuryl methacrylate, and ethyl-n-hexyl methacrylate and combinations thereof. More preferred acrylic monomers include methyl acrylate, n-butyl acrylate, isobornyl acrylate, ethyl-n-hexyl acrylate, methyl methacrylate, hydroxyethyl acrylate, and combinations thereof.

The term “curable acrylic-based paint” is used herein to refer to a liquid formulation that contains an acrylic monomer, a solvent, and optionally one or more additives including pigments, dyes, thickeners, thixotropic agents, fillers, driers, antioxidants, levelers, surfactants, and crosslinkers. The curable acrylic-based paint can be cured by contacting together the curable paint, the complex, and a borane-displacing initiator to form a curing acrylic-based paint—curing because polymerization of the monomers has been initiated but not completed—concomitantly or subsequently applying the curing paint to a substrate, preferably a low surface energy substrate, and then allowing the curing paint to cure.

The term “borane-displacing initiator” is used herein to describe a chemical that displaces trialkylborane from the trialkylborane-organonitrogen complex. The term “curing acrylic-based paint” is used herein to refer to a paint that is in the process of curing. The term “low surface energy substrate” is used herein to refer to a polymeric hydrocarbon, a polymeric fluorocarbon, or a polymeric hydrofluorocarbon substrate that does not include polar substituents. Examples of low surface energy substrates include polyethylenes, polypropylenes including isotactic and syndiotactic polypropylenes, ethylene-α-olefin copolymers including as ethylene-1-octene- and ethylene-1-butene-copolymers, hydrogenated polyisoprene (also known as poly(ethylene-alt-propylene)), polyvinylidene fluorides, polytetrafluoroethylenes, polyesters, polyamides, polyacetals, polystyrenes, and blends thereof.

A preferred thixotropic agent is a polymeric acrylic such as poly(methyl acrylate), poly(ethyl acrylate), poly(n-propyl acrylate), poly(n-butyl acrylate), poly(t-butyl acrylate), poly(carboxyethyl acrylate), poly(methyl methacrylate), poly(ethyl methacrylate), poly(n-propyl methacrylate), poly(n-butyl methacrylate), poly(t-butyl methacrylate), and poly(carboxyethyl methacrylate). A preferred thixotropic agent is poly(methyl methacrylate), which preferably has a weight average molecular weight (M_{w}) of not less than 50,000, and more preferably not less than 75,000 Daltons, and preferably not greater than 500,000, and more preferably not greater than 400,000 Daltons.

As used herein, the term “trialkylborane-organonitrogen complex” is used to refer to an oxidatively stable complex of a trialkylborane and a nitrogen-containing organic compound. The alkyl groups are preferably each independently C₁-C₁₀-alkyl or C₁-C₁₀-alkylcycloalkyl, more preferably C₁-C₅-alkyl. Examples of nitrogen-containing organic compounds include substituted or unsubstituted primary amines, secondary amines, tertiary amines, diamines, pyridines, pyrrolidines, pyrroles, carbazoles.

Examples of preferred borane-organonitrogen complexes include triethylborane:dimethylaminopropylamine complex, tributylborane:dimethylaminopropylamine complex, triethylborane:pyrrolidine complex, tributylborane:pyrrolidine complex, triethylborane:pyridine complex, tributylborane:pyridine complex, triethylborane:isophorone diamine complex, triethylborane:isophorone diamine complex, tributylborane:isophorone diamine complex, triethylborane:methoxypropylamine complex, and tributylborane:methoxypropylamine complex.

The trialkylborane-organonitrogen complex can be prepared by contacting a trialkylborane compound, either neat or as a trialkyborane etherate complex, with a nitrogen-containing organic compound, preferably with a stoichiometric excess of the nitrogen-containing compound. For example, a preferred tri-n-butylborane:3-methoxypropylamine complex contains from about a 1:1.1 to about a 1:1.5 mole ratio of tri-n-butylborane to 3-methoxypropylamine.

The curable paint contains a solvent, examples of which include ketone such as acetone and methylethyl ketone, esters such as ethyl acetate, n-propyl acetate, isopropyl acetate, n-butyl acetate, and isopropyl acetate; chlorinated solvents such as methylene chloride and chloroform; ethers such as diethyl ether; hydrocarbon solvents such as hexane, heptane, petroleum ethers; and combinations thereof. The concentration of the solvent in the paint is preferably at least 5, more preferably at least 10, and more preferably at least 15 weight percent, and preferably not greater than 60, more preferably not greater than 50, and more preferably not greater than 40 weight percent, based on the weight percent of monomer, trialkylborane-organonitrogen complex, solvent, and the additives.

The concentration of the acrylic monomer in the paint formulation depends on the coating technique used to coat the paint but is preferably at least 10, more preferably at least 30, and most preferably at least 40 weight percent, and preferably not greater than 90, more preferably not greater than 75 weight percent, and most preferably not more than 65 weight percent based on the weight percent of monomer, trialkylborane-organonitrogen complex, the solvent, and the additives.

The concentration of the trialkylborane-organonitrogen complex is preferably at least 0.5, more preferably at least 2, and most preferably at least 3 weight percent, and preferably not greater than 10, more preferably not greater than 8, and most preferably not greater than 7 weight percent based on the weight percent of monomer, the trialkylborane-organonitrogen complex, the solvent, and the additives.

The borane-displacing initiator is characterized by its ability to displace the trialkylborane from the trialkylborane:organonitrogen complex. Examples of suitable initiators include acids such as acetic acid, acrylic acid, methacrylic acid, formic acid, as well as isocyanates, aldehydes, ketones, acid chlorides, and anhydrides. Preferred initiators include acrylic acid and methacrylic acid. The amount of initiator used is preferably not less than 0.1, more preferably not less than 1, and most preferably not less than 2 weight percent, and not more than 20, more preferably not more than 10, and most preferably not more than 8 weight percent based on the weight of the initiator, the monomer, the trialkylborane-organonitrogen complex, the solvent, and the additives.

The method of the present invention provides a simple way to paint a low surface energy substrate at room temperature without the aid of any surface pretreatment. The method entails contacting together the curable acrylic-based paint, the trialkylborane-organonitrogen complex, and the borane-displacing initiator to provide a curing paint with concomitant or subsequent application of the curing paint onto the substrate to form a cured paint, which may also be used as a primer for subsequent coating applications.

Concomitant application can occur where the curable paint, the complex, and the initiator are brought into contact with each other by a plural component sprayer at about the same time these components are contacting the substrate. For example, the complex can be delivered from one of the outlets of the plural component sprayer, the initiator from another, and the curable paint and optionally ancillary solvent may be delivered from either or both of the outlets or may be delivered from other outlets of the plural component sprayer. The following table illustrates some of the possibilities of concomitant addition using a plural component sprayer:

| outlet 1 | outlet 2 | outlet 3 |
|---|---|---|
| complex/paint | initiator/solvent | — |
| initiator/paint | complex/solvent | — |
| initiator/paint | complex/paint | — |
| complex/paint | initiator | solvent |
| initiator/paint | complex | solvent |
| initiator/solvent | complex/solvent | paint |

Subsequent application occurs where the curable paint is first contacted with the complex, then this mixture is contacted with the initiator, with or without curable paint and with or without ancillary solvent, then this resultant curing paint is applied to the substrate by, for example, a brush or a roller. Alternatively, the curable paint can be contacted with the initiator first, then this mixture can be contacted with the complex to form the curing paint. After application to the substrate, the curing paint is allowed to cure, preferably at room temperature for from about 10 to 100 hours, to form a adherent cured paint with a cross-hatch failure of preferably less than 30%, more preferably less than 20%, and most preferably less than 10%, based on ASTM method D-3359-83.

The following examples are for illustrative purposes only and are not intended to limit the scope of the invention. All percentages are by weight unless otherwise noted.

### EXAMPLE 1

### Preparation and Application of a Low Surface Energy Paint Formulation

A low surface energy curable paint was prepared by combining at room temperature methyl methacrylate (42%), 2-hydroxyethyl acrylate (6.5%), acrylic acid (5.2%), polymethyl methacrylate-co-ethyl acrylate (16%, M_{w} 101,000, <5% ethyl acrylate obtained from Aldrich Chemical Milwaukee, Wis.). These acrylate components were pre-mixed by rolling to provide a homogeneous resin mixture. To this resin mixture is added acetone (19.4%), Kynar 741 powder (5% Polyvinylidene fluoride, a product of Atofina Chemicals Philadelphia, Pa.), and copper II phthalocyanine blue dye (0.7%) and mixed for 2 minutes using a high shear air driven cowles mixer. This blend was combined with a trialkylamine:organonitrogen complex (5.2% tri-n-butylborane:3-methoxypropylamine, based on the weight of the complex and the curable paint, containing 1:1.3 mole ratio of tri-n-butylborane to 3-methoxypropylamine) and stirred for 30 seconds. The resultant curing paint formulation was spray applied to the surface of isotactic polypropylene coupon at a thickness of 4 mils (0.1 mm) and allowed to cure for 48 hours. The painted surface was then tested for adhesion by ASTM method D 3359-83 and for hardness by ASTM method D 3363-00. By these methods the coating exhibited no adhesion failure and a pencil hardness of H.

### EXAMPLES 2-10

### Adhesion of Cured Paints on Isotactic Polypropylene Substrate

The formulation quantities in Table 1 are expressed in weight ratios relative to the mass fraction of the total components. In the following formulations the resin refers to a mixture of 75% methyl methacrylate and 25% poly(methyl methacrylate) (M_{w}=101,000). BA refers to butyl acrylate, 2-EHA refers to 2-ethylhexyl acrylate, IBMA refers to isobornyl methacrylate, and MA refers to methyl acrylate. All coatings are additionally formulated with the trialkylborane:organonitrogen complex described in Example 1 (5.7%), acrylic acid (5.7%), Kynar 741 powder (7.1%), copper II pthalocyanine dye (0.5%), and diethyl ether (21.4%). Example 4 has in addition 0.7% of ethylene glycol dimethacrylate. In all cases the painted substrate is isotactic polypropylene. A failure of 0 indicates no loss of adhesion resulting from the adhesion test.

TABLE 1

| | | | Film | | |
|---|---|---|---|---|---|
| | % | thickness | | | |
| Example | Resin | monomer (%) | mil (mm) | failure | hardness |
| 2 | 56 | BA (3.6) | 13 (0.33) | 0 | HB |
| 3 | 52.5 | BA (7.1) | 12 (0.30) | 0 | HB |
| 4 | 51.8 | BA (7.1) | 10 (0.25) | 0 | 1H |
| 5 | 49.2 | 2EHA (10.7) | 11 (0.28) | 0 | 3B |
| 6 | 49.2 | 2EHA (10.7) | 4 (0.10) | 0 | 3B |
| 7 | 56 | IBMA (3.6) | 7 (0.18) | 0 | HB |
| 8 | 56 | MA (3.6) | 15 (0.38) | 0 | HB |
| 9 | 52.5 | MA (7.1) | 9 (0.23) | 0 | HB |
| 10 | 49.2 | MA (10.7) | 8 (0.2) | 0 | 1B |

What is claimed is:

1. A composition comprising a mixture of a curable acrylic-based paint and a trialkylborane-organonitrogen complex, wherein the curable acrylic-based paint contains a solvent and an acrylic monomer.

2. The composition of claim 1 where the acrylic monomer is an acrylate monomer having the chemical structure: 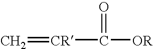
where R is alkyl, cycloalkyl, bicycloalkyl, or hydroxyalkyl; and R′ is hydrogen or C₁-C₆-alkyl.

3. The composition of claim 1 wherein the alkyl groups of the trialkylborane-organonitrogen complex are each independently C₁-C₁₀-alkyl groups and wherein the organonitrogen is selected from the group consisting of primary amines, secondary amines, tertiary amines, diamines, pyridines, and pyrrolidines.

4. The composition of claim 2 wherein the borane-organonitrogen complex is selected from the group consisting of triethylborane:dimethylaminopropylamine complex, tributylborane:dimethylaminopropylami ne complex, triethylborane:pyrrolidi ne complex, tributylborane:pyrrolidine complex, triethylborane:pyridine complex, tributylborane:pyridine complex, triethylborane:isophorone diamine complex, triethylborane:isophorone diamine complex, tributylborane:isophorone diamine complex, triethylborane:methoxypropylamine complex, and tri butylborane:methoxypropylamine complex.

5. The composition of claim 4 wherein the borane-organonitrogen complex is selected from the group consisting of tri-n-butylborane:3-methoxypropylamine and triethyl borane methoxy propylamine.

6. The composition of claim 1 wherein the acrylic-based paint precursor contains at least one additive selected from the group consisting of pigments, dyes, thickeners, thixotropic agents, fillers, driers, antioxidants, levelers, surfactants, and crosslinkers.

7. The composition of claim 6 wherein the thixotropic agent is a poly(methyl methacrylate).

8. The composition of claim 7 wherein the solvent is selected from the group consisting of ketones, esters, chlorinated solvents, and ethers.

9. The composition of claim 1 which further includes a borane-displacing initiator selected from the group consisting of acids, isocyanates, acid chlorides, and anhydrides.

10. The composition of claim 9 wherein the borane-displacing initiator is selected from the group consisting of acrylic acid and methacrylic acid.

11. A method comprising the steps of 1) contacting together a curable acrylic-based paint, a trialkylborane-organonitrogen complex, and a trialkyborane-displacing initiator to form a curing acrylic-based paint; and 2) applying the curing paint to a substrate; and 3) allowing the curing paint to cure.

12. The method of claim 11 wherein the curable paint is first contacted with the complex to form a mixture, then the trialkyborane-displacing initiator is contacted with the mixture of the curable paint and the complex.

13. The method of claim 11 wherein the curable paint is first contacted with the initiator to form a mixture, then the complex is contacted with the mixture of the curable paint and the initiator.

14. The method of claim 11 wherein the curable paint, the complex, and the initiator are sprayed onto the substrate using a plural-component sprayer having a plurality of outlets, wherein the curable paint and the initiator are delivered through one of the outlets and the complex and, optionally, the curable paint or ancillary solvent or both, are delivered through one or more of the other outlets.

15. The method of claim 11 wherein the substrate is a low surface energy substrate selected from the group consisting of polyethylenes, polypropylenes, ethylene-α-olefin copolymers, hydrogenated polyisoprene, polyvinylidene fluorides, polytetrafluoroethylenes, polyesters, polyamides, polyacetals, and polystyrenes.

16. The method of claim 15 wherein the substrate is isotactic polypropylene.

17. A composition comprising a mixture of a curing acrylic-based paint, a borane-displacing initiator, and a trialkylborane-organonitrogen complex, wherein the curing acrylic-based paint contains a solvent and a polymerizing acrylic monomer, the borane-displacing initiator is selected from the group consisting of acids, isocyanates, acid chlorides, and anhydrides, and wherein the organonitrogen is selected from the group consisting of primary amines, secondary amines, tertiary amines, diamines, pyridines, and pyrrolidines.

18. The composition of claim 17 wherein the curing acrylic-based paint includes a polymerizing acrylate monomer selected from the group consisting of methyl acrylate, n-butyl acrylate, isobornyl acrylate, ethyl-n-hexyl acrylate, methyl methacrylate, hydroxyethyl acrylate, and combinations thereof; the borane displacing initiator is selected from the group consisting of acrylic acid and methacrylic acid, and the trialkylborane-organonitrogen complex is selected from the group consisting of tri-n-butylborane:3-methoxypropylamine and triethyl borane methoxy propylamine.

19. The composition of claim 18 wherein the curing paint further includes one or more additives selected from the group consisting of pigments, dyes, thickeners, thixotropic agents, fillers, driers, antioxidants, levelers, surfactants, and crosslinkers.

20. The composition of claim 19 which is coated onto a low surface energy substrate selected from the group consisting of polyethylenes, polypropylenes, ethylene-α-olefin copolymers, hydrogenated polyisoprene, polyvinylidene fluorides, polytetrafluoroethylenes, polyesters, polyamides, polyacetals, and polystyrenes, then allowed to cure to form a adherent cured paint with a cross-hatch failure of less than 10%, based on ASTM method D-3359-83.

21. The composition of claim 19 which is used as a primer for subsequent coating operations.
